(19) United States
(12) Patent Application Publication
(10) Pub. No.: US 2020/0348529 A1
(43) Pub. Date: Nov. 5, 2020

(54) LAYERED OPTICAL DEVICE

(71) Applicant: Catrinel Sabaciag, Cluj-Napoca (RO)

(72) Inventor: Catrinel Sabaciag, Cluj-Napoca (RO)

(21) Appl. No.: 16/934,088

(22) Filed: Jul. 21, 2020

(30) Foreign Application Priority Data
Jun. 3, 2020 (RO) U2020 00021

(51) Int. Cl. G02B 27/28; G02B 26/02; G02B 5/30

(52) U.S. Cl. CPC G02B 27/281; G02B 5/3083; G02B 26/023

(57) ABSTRACT

A layered optical device has been disclosed herein that allows adjustment of light intensity as well as colors of the light that passes through it. The layered optical device includes three main parts such as a rear part, a front part, and a middle part. The middle part is placed between the rear part and the front part by using a hinge type mechanism, which allows a lid to move laterally relative to the other two parts. The layered optical device is configured so that the intensity and color spectrum of the light passing through it may be adjustable depending on a rotation angle of the front polarizer relative to the rear polarizer, the optical characteristics of the birefringent component, the position of the birefringent component relative to the front polarizer, and the rear polarizer and a viewing angle.

### CROSS-REFERENCE TO RELATED PATENT DOCUMENTS

This patent application claims the benefit of priority of Romanian Application No. U2020 00021 entitled “LAYERED OPTICAL DEVICE,” filed on Jun. 3, 2020, which is hereby incorporated herein by reference in its entirety.

### FIELD OF THE INVENTION

The present invention relates generally to an optical device and, more particularly, to a layered optical device for adjusting the intensity and colors of light, which allows visualization of the spectrum of white light through processes of diffraction, refraction, birefringence, and interference.

### BACKGROUND

The color and intensity of light play a major role in the human sleep cycle. This can regulate many bodily functions, from appetite and metabolism, up to hormone levels and immune system. Scientific studies conducted in the last two decades have shown that certain intensities and light colors can cause disruptions in the circadian rhythm, which can have a major health impact, for example, leading to sleep disorders, obesity, depression, diabetes, or the like.

Consequently, in the design of some recent lighting installations, emphasis has been placed on the spectral composition of light, considering the psychological and physiological influence it has on humans. A number of clinical studies have shown that sleep is significantly improved by red light therapy. Further, exposure to red light is ideal for use during the evening time because it has a low color temperature, much lower than regular sunlight. The red light has been proved to increase the secretion of melatonin. Also, a recent 2018 Brazilian research project, which had evaluated the effects of red light therapy and other treatments on patients with migraines, found that not only did the red light therapy reduce pain and headache, but it was the only treatment that also improved the condition of the patients suffering from sleep disorders. Further research has also shown that blue light is beneficial during daytime because it is part of the high frequency daylight spectrum, which stimulates attention and cognitive function and improves reaction time and general mood. Therefore, light therapy has been included in the treatment of certain diseases, which could be influenced by light, such as anxiety, depression seasonal affective disorder (SAD), or the like.

Several products from a wide range of fields have been developed in order to make use of the polarized light effects such as polarized sunglasses, LCD screens for various electronic devices, polarized decorative paintings, microscopes with polarized lenses as well as other devices that use optical phenomena such as refraction and birefringence like polariscopes. These instruments or devices experimentally determine the stress distribution in a material. Furthermore, instruments or devices incorporating birefringent materials are used for didactic purposes in understanding optical phenomena. However, each of the prior art products makes use of only one effect, for example, either allowing the adjustment of light intensity using linear polarization effects or incorporating a single birefringent material having a single-color effect. In addition, none of the prior art products allows the simultaneous adjustment of the light intensity and the color frequency according to a set of predetermined values imposed by specific technical requirements dictated by certain applications in various fields.

The light effects created by the prior art products are static, cannot be adjusted, have no option for changing the light's color using two polarizers, and a wide range of interchangeable birefringent materials. The devices presented in the prior art do not offer versatility and adaptability in terms of changing the light source's intensity and colors at the same time. The polarization effects described have not been used in furniture and home decor objects. In light of the foregoing, there exists a need for a technical and reliable solution that solves the above-mentioned problems and presents an improved, efficient and effective optical device. The prior art problems are solved by the present invention by creating or designing a device that allows the adjustment of the light intensity as well as the colors of the light that passes through, thus, obtaining a wide spectrum of intensities and colors of light, which can be predetermined according to the technical requirements specific to its use.

### SUMMARY

It will be understood that this disclosure is not limited to the particular systems and apparatus described herein, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

An objective of the present invention is to provide a layered optical device that allows the adjustment of the light intensity as well as the colors of the light that passes through it, thus, obtaining a wide spectrum of intensities and colors of light, which can be predetermined according to the technical requirements specific to its use.

The layered optical device removes the limitations of the prior art products and is configured so that the intensity and color spectrum of the light passing through it can be adjusted to different intensities and colors according to certain specified technical requirements. The layered optical device includes three main parts such as a rear part, a front part, and a middle part. The middle part is placed between the rear part and the front part by using a hinge type mechanism, which allows the middle part or a lid to move laterally relative to the other two parts. Further, the layered optical device has been provided in which:
the rear part is designed to include a rear polarizer
the front part is designed to include:
a front polarizer
means for enclosing the front polarizer which allow the front polarizer to rotate around its center of mass relative to the rear polarizer
means for rotating the front polarizer
the middle part is designed to embody a birefringent component that enables visualization of the light that passes through under the phenomenon of birefringence, refraction, and polarization.

The layered optical device is configured so that the intensity and color spectrum of the light passing through it may be adjusted depending on the rotation angle of the front polarizer relative to the rear polarizer, the optical characteristics of the birefringent component, the position of the birefringent component relative to the front polarizer, and the rear polarizer and the viewing angle.

Each of the front polarizer and the rear polarizer comprises a linear, circular, elliptical, or rotary polarization filter and is configured so that the intensity of the polarized light passing through the optically layered device is adjusted by rotating the front filter using its means of rotating relative to the rear filter. Further, the means for enclosing the front polarizer, which enable the rotation of the front polarizer in a front channel, are formed by two rings including an outer ring, which is configured to be mounted in a front channel, and an inner ring, which is configured to encase the front polarizer and rotate it inside the outer ring.

The birefringent component comprises a birefringent material that is selected from the following elements, separately or in combination: (1) stretched cellophane strips that is arranged in three-dimensional shapes, (2) wrinkled adhesive tape that are arranged in three-dimensional shapes, (3) layered adhesive tape formed by overlapping layers of adhesive tape, (4) polycarbonate parts in the shape of disks or other geometrical shapes, and (5) Polyethylene Terephthalate Glycol (PET-G) parts in the shape of disks or other geometrical shapes. These materials are configured to be incorporated into the birefringent component according to predetermined birefringent optical characteristics and the light intensity and color spectrum desired.

Further, the layered optical device is composed of a housing comprising the rear part and the front part that are designed to have a fixed position, whilst the middle part has a lid, which can rotate laterally in relation to the other two parts, and means for fastening the lid, which enable a lateral rotational movement in relation to the front polarizer and the rear polarizer, and allow the position of the birefringent component to be adjusted relative to the two polarizers, the front polarizer and the rear polarizer. By rotating the birefringent component of the middle part to predetermined positions it either completely overlaps with the front polarizer and the rear polarizer or it is placed outside the two polarizers.

Further, the birefringent component is composed of an outer ring configured to comprise inside two transparent disks and a birefringent material placed between the two disks which are made of glass, acrylic, or other material with similar optical properties. The middle part is composed of a middle channel configured to comprise the birefringent component, having a folding part that is configured so that it allows insertion of the birefringent component in the middle channel. Further, at least one of the front polarizer or the rear polarizer comprises one or two transparent plates on which polarization filters are glued on, or are placed between two disks made of glass, acrylic, or other material with similar optical properties.

In an embodiment, the layered optical device is adapted to be incorporated in a luminaire such as a wall lamp, a ceiling lamp, a desk lamp, or other similar lighting devices. Further, means for incorporating the device into a luminaire are the rear part of the housing comprising a light source mounted on the inner circumference of the housing in the rear area, and a posterior canal adapted to comprise at least one light guide plate, at least one light-reflecting film, and a light diffusion plate that is placed between the light guide plate and the rear polarizer.

In an embodiment, the layered optical device is adapted to be incorporated into a piece of furniture such as a table. The layered optical device may also be adapted to be incorporated into a wall or a room divider. The layered optical device may also be adapted to be incorporated into a clock or an automatically rotative luminaire.

Further, means for mounting the front polarizer, which allow the front polarizer to rotate relative to the rear polarizer and the birefringent component, comprise a pivoted rod. These means allow the front polarizer, the rear polarizer, and the birefringent component to be mounted and rotated around the pivoted rod in predetermined positions, which helps in obtaining predetermined values of light intensity and color frequencies.

The layered optical device presented herein has the following advantages:
Reduces ocular discomfort caused by light under certain conditions. Further, ambient light passes through the layered optical device's polarizers, thus becoming polarized light. This reduces glare reflected from surfaces and thus diminishes eye strain.
Allows the user to adjust the light intensity according to his (or her) needs, activities, and moods. By rotating the front polarizer, the amount of light passing through the layered optical device may be varied depending on the predefined technical requirements. Furthermore, by altering the light intensity that passes through the layered optical device, the degree of visibility is also adjustable, thus offering the user privacy when desired.
It is a product with a simple construction, which can easily adapt to the user's needs and activities only by making use of the optical properties of the materials.
It is a versatile product, which can be incorporated into several objects such as room dividers and windows, thus enabling adjustable light intensity and visibility/privacy.
It can be part of one or more devices such as lighting fixtures, or wall clocks which use light therapy as treatment for certain psychological disorders.

These and other features and advantages of the present invention will become apparent from the detailed description below, in light of the accompanying drawings.

### BRIEF DESCRIPTION OF ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrates a side view of a wall lamp comprising a layered optical device, according to an exemplary embodiment of the present invention;

FIG. 2 is a diagram that illustrates a front view of the wall lamp comprising the layered optical device, according to an exemplary embodiment of the present invention;

FIG. 3 is a diagram that illustrates a front view of the wall lamp comprising the layered optical device, in which an opening-closing mechanism of a middle channel's cover is shown, according to an exemplary embodiment of the present invention;

FIG. 4 is a diagram that illustrates a side view of a table lamp comprising a layered optical device, according to an exemplary embodiment of the present invention;

FIG. 5 is a diagram that illustrates a front view of the table lamp comprising the layered optical device, according to an exemplary embodiment of the present invention;

FIG. 6 is a diagram that illustrates a front view of the table lamp comprising the layered optical device, in which an opening-closing mechanism of a middle channel's cover is shown and depicted for illustrative purpose, according to an exemplary embodiment of the present invention;

FIG. 7a is a diagram that illustrates a cross-sectional side view of the table lamp, according to an exemplary embodiment of the present invention;

FIG. 7b is a diagram that illustrates a detailed view of the cross-sectional side view of the table lamp presented in FIG. 7a, according to an exemplary embodiment of the present invention;

FIG. 8, FIG. 9, and FIG. 10 are diagrams that illustrate a cross-sectional side views of a birefringent component in several embodiment types such as a wrinkled tape type, a stretched cellophane type, a poly-carbonate type, or a PET-G plate type, according to an exemplary embodiment of the present invention;

FIG. 11a, FIG. 11b, and FIG. 11c are diagrams that illustrate front views of the inserting mechanism of the birefringent component into the frame and the closing mechanism of the middle channel cover, according to an exemplary embodiment of the present invention;

FIG. 12, FIG. 13, FIG. 14, and FIG. 15 are diagrams that illustrate front views of different types of the birefringent component, such as a stretched cellophane type, wrinkled adhesive tape type, PET-G type, polycarbonate type, or a layered adhesive tape type, according to an exemplary embodiment of the present invention;

FIG. 16 is a diagram that schematically presents insertion of the different types of the birefringent component depicted in FIGS. 12-15 into the frame, which is shown with a lid open, according to an exemplary embodiment of the present invention;

FIG. 17a, FIG. 17b, and FIG. 17c are diagrams that illustrates front and perspective views of the birefringent component, in which a birefringent material of the layered adhesive tape type has been shown, according to an exemplary embodiment of the present invention;

FIG. 18a, FIG. 18b, FIG. 18c, and FIG. 18d are diagrams that illustrate various embodiments of the birefringent materials polycarbonate or PET-G in front view, according to an exemplary embodiment of the present invention;

FIG. 19a, FIG. 19b, FIG. 19c, and FIG. 19d are diagrams that illustrate front views of the birefringent component of the layered adhesive tape type in various options, according to an exemplary embodiment of the present invention;

FIG. 20a, FIG. 20b, and FIG. 20c are diagrams that illustrate front views of a wrinkled tape type birefringent component in various options, according to an exemplary embodiment of the present invention;

FIG. 21a, FIG. 21b, and FIG. 21c are diagrams that illustrate front views of the birefringent component of stretched cellophane type in various options, according to an exemplary embodiment of the present invention;

FIG. 22, FIG. 23, FIG. 24, and FIG. 25 are diagrams that illustrate the layered optical device without an artificial light source, according to an exemplary embodiment of the present invention;

FIG. 26 is a diagram that illustrates an exploded view of the layered optical device shown in FIG. 23, according to an exemplary embodiment of the present invention;

FIG. 27, FIG. 28, FIG. 29, and FIG. 30 are diagrams that illustrate various embodiments of the layered optical device, which do not comprise a lighting source and incorporate several types of birefringent materials, according to an exemplary embodiment of the present invention;

FIG. 27a and FIG. 30 are diagrams that illustrate an exploded view of the layered optical device with its components, according to an exemplary embodiment of the present invention;

FIG. 31, FIG. 32, and FIG. 33 are diagrams that illustrate variants of a luminaire comprising the layered optical device with interchangeable birefringent materials, according to an exemplary embodiment of the present invention;

FIG. 33a is a diagram that illustrates an exploded view of the luminaire, according to an exemplary embodiment of the present invention;

FIG. 34, FIG. 35, FIG. 36, and FIG. 37 are diagrams that illustrate front views of several variants of the luminaire, comprising the layered optical device, where the three main components have different shapes, according to an exemplary embodiment of the present invention;

FIG. 34a, FIG. 35a, FIG. 36a, and FIG. 37a are diagrams that illustrate perspective views of the lamp variants, according to an exemplary embodiment of the present invention;

FIG. 34b is a diagram that illustrates an exploded view of the lamp of FIG. 34 and FIG. 34a, according to an exemplary embodiment of the present invention;

FIG. 38a and FIG. 38b are diagrams that illustrate a perspective view of the layered optical device without an embedded artificial light source incorporated in a table, according to an exemplary embodiment of the present invention;

FIG. 39a, FIG. 39b, and FIG. 39c are diagrams that illustrate front and perspective views of the layered optical device without an embedded artificial light source incorporated in a room divider, according to an exemplary embodiment of the present invention;

FIG. 40, FIG. 40a, and FIG. 40b are diagrams that illustrate front, exploded, and perspective views, respectively, of the layered optical device without an artificial light source, according to an exemplary embodiment of the present invention;

FIG. 41a and FIG. 42a are diagrams that illustrate front views of variants of the layered optical device adapted to be incorporated in a clock or automatically rotated luminaire, according to an exemplary embodiment of the present invention; and

FIG. 41b and FIG. 42b are diagrams that illustrate exploded views of the embodiments shown in FIG. 41a and FIG. 42a, according to an exemplary embodiment of the present invention.

Further areas of applicability of the present invention will become apparent from the detailed description provided hereinafter. It should be further understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a layered optical device. This layered optical device allows adjustment of light intensity as well as the spectrum of colours that passes through it, thus, obtaining a wide spectrum of intensities and light colors, which can be predetermined according to the technical requirements specific to its use. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

Before describing the present invention in detail, following reference numerals, as shown in various figures of the drawing section, have used without any limitation:

1. Layered optical device housing has been shown by a reference numeral 101

1.1. Back has been shown by a reference numeral 101a
1.1.1. The posterior canal has been shown by a reference numeral 101aa

1.2. Middle part has been shown by a reference numeral 101b
1.2.1. Middle channel has been shown by a reference numeral 101ba

1.3. Front has been shown by a reference numeral 101c
1.3.1. Front channel has been shown by a reference numeral 101ca
   2. The middle part cover has been shown by a reference numeral 102
   3. Front polarizer rotation nob has been shown by a reference numeral 103
   4. Power cord has been shown by a reference numeral 104
   5. Table lamp holder has been shown by a reference numeral 105
   6. Outer front ring has been shown by a reference numeral 106
   7. Inner front ring has been shown by a reference numeral 107
   8. Front polarizer has been shown by a reference numeral 108

8.1. Front polarization filter (not shown specifically but is incorporated within 108)

8.2. Transparent front plate (not shown specifically but is incorporated within 108)

9. Birefringent component has been shown by a reference numeral 109

9.1. Outer ring has been shown by a reference numeral 109a
9.1.1. Metal, plastic, or wooden frame has been shown by a reference numeral 109aa

9.2. Birefringent material has been shown by a reference numeral 109b
9.2.1. Wrinkled adhesive tape type birefringent material has been shown by a reference numeral 109ba
9.2.2. Stretch cellophane birefringent material has been shown by a reference numeral 109bb
9.2.3. PET-G or polycarbonate birefringent material has been shown by a reference numeral 109bc
9.2.4. Layered scotch tape birefringent material has been shown by a reference numeral 109bd

9.3. Transparent plate of the birefringent component has been shown by a reference numeral 109c

10. Lighting source has been shown by a reference numeral 110
11. Rear polarizer has been shown by a reference numeral 111

11.1. Rear polarization filter (not shown)

11.2. Transparent rear plate (not shown)

12. Light diffusion plate has been shown by a reference numeral 112
13. Light guide panel has been shown by a reference numeral 113
14. White reflective foil has been shown by a reference numeral 114
15. Rotation pivot has been shown by a reference numeral 115
16. Room divider has been shown by a reference numeral 116
17. Automatic rotating mechanism has been shown by a reference numeral 117

The layered optical device of the present invention will now be described with reference to the accompanying drawings, which should be regarded as merely illustrative without restricting the scope and ambit of the present invention. Embodiments of the present invention will now be described with reference to all figures as briefly described above.

The layered optical device with adjustable polarization has a circular or polygonal shape, which could be triangular, square, rectangular, hexagonal, or other irregular polygon shape and has three main parts such as a rear 101a, a middle 101b, and a front 101c. In one embodiment of the invention, the layered optical device comprises a housing 101 comprising the three main parts such as the rear 101a, the middle 101b, and the front 101c. The housing 101 of the layered optical device may be made of metal, plastic or wood or other similar material. The middle part 101b is placed between the rear part 101a and the front part 101c. A hinge system allows the middle part's cover 102 to rotate in relation to the other two parts. The layered optical device uses adjustable polarization and has several features allowing it to be adapted to be integrated into various lighting fixtures, such as ceiling, wall, table lamps, in partition walls or room divider, or various pieces of furniture, as well as in many other products that use the spectrum of light for functional and decorative purposes. When it is adapted to be integrated in a wall-mounted luminaire, the layered optical device has a housing which is configured to be fixed on the wall with screws or other fasteners. If the lighting object is designed to be placed on a surface, such as table and desk lamps, it will have a base, which will ensure the components' verticality. The base stand can have a slot in which the layered optical device can be fixed. The supporting base can be made of stones such as marble, granite, onyx, etc. or resin, wood. The rear part 101a is fixed and is composed of a channel which houses a rear polarizer 111 comprising a polarization filter (not shown). In one embodiment of the invention, the polarizing filter may be glued on a transparent disk (not shown) or placed between two disks which may be made of glass, acrylic or other similar material. In embodiments where the layered optical device is adapted as a luminaire, the rear part 101a incorporates a light source 110, which may be a LED strip or LED light bulbs or diodes, which can be arranged in various ways on the back plate of the rear part 101a or on the inside circumference of the channel. In embodiments in which the layered optical device is adapted to be integrated into a luminaire, the channel of the posterior part 101a is also configured to comprise, between the backplate of the housing 101 and the rear polarizer 111, the following: a light diffusion plate 112, which can be made of polystyrene or polycarbonate, a light guide plate 113, which can be engraved or optically structured to uniformly distribute the light, and a white reflective foil 114.

The middle part 101b of the housing 101 incorporates a moving element 102 that is made of the same material as the housing 101 of the optically layered device, which can be mounted on the housing 101 by means of a hinge-type joint or other fastening mechanism which allows it to move sideways in relation to the two polarizers, the front polarizer 108 and the rear polarizer 111, respectively. The middle part 101b is designed to incorporate a birefringent component 109 which allows the visualization of the light passing through and making use of optical phenomenon like birefringence, refraction, and polarization. In some embodiments, the middle part 101b comprises a channel in which the birefringent component 109 is placed. The latter can comprise various types of transparent birefringent materials 109b, which can be placed between two transparent disks 109c. All three components are fixed in an outer ring 109a. The transparent disks 109c of the birefringent component 109 may be made of acrylic or glass, and the outer ring 109a may be made of plastic, wood, Teflon, metal, or other similar materials. The front 101c is comprised of a means of enclosing the front polarizer 108 which enable a smooth rotation around its center of mass relative to the rear polarizer 111 and a means for rotating the front polarizer 108. In some embodiments of the invention, the front part 101c is provided with a channel and the means for enclosing the front polarizer 108 which enables its rotation in the front channel. These means are comprised of 2 rings, an outer ring 106 mounted in the front channel 101ca and an inner ring 107 which is configured to enclose the front polarizer 108 and rotate inside the outer ring 106. The channel houses the front polarizer 108, which is comprised of a polarization filter (not shown) which can be glued or placed between the transparent disks (not shown), which could be made of any transparent material, such as plastic, acrylic, or glass. The two filters, such as the front filter and the rear filter, may be linear, circular, elliptical, or rotary polarization filters. The layered optical device is configured so that the intensity and color spectrum of the light passing through are adjustable according to the rotation angle of the front polarizer 108 relative to the rear polarizer 111, the optical characteristics of the birefringent component 109, the position of the birefringent component 109 relative to the front polarizer 108, and the rear polarizer 111 and the viewing angle.

When white light passes through the layered optical element according to the invention, respectively, through the two polarizers and the birefringent component 109, the phenomenon of refraction, polarization, and birefringence occur, so that the light is dispersed in vivid rainbow colors. When the front polarizer 108 is rotated, these colors change, as does the light intensity in areas where the birefringent material is not placed due to the linear polarization effect. The polarization filter is a material that allows light to pass in a single direction or orientation relative to the light propagation axis. Thus, the rear polarizing filter polarizes the ray of light passing through it, so that its electric field oscillates in only one direction in relation to the light propagation axis. When the front polarizer 108 is rotated at an angle of 90 degrees relative to the posterior polarizer, all light is blocked. The birefringent materials placed between the two polarizers act as prisms, and, as a result of the rotation of the polarizers, the frequencies of the colors passing through the front polarizer 108 change. The material has birefringent properties, which means that the color of the refracted light changes depending on the viewing angle. Birefringence is the property of birefringent materials to produce, due to their optical anisotropy, the phenomenon of double refraction, whereby a ray of light is split by polarization into two rays taking slightly different paths. By placing the birefringent material between the polarizers, the incident light falling on the material is divided into two components whose amplitude and intensity are variable depending on the orientation of the angle formed by the polarizer and the birefringent material. These materials display different light effects and colors depending on the thickness of the material, the shape in which they were arranged, and the way they were formed and manipulated. Certain materials such as cellophane and other plastics that are not birefringent by default can become birefringent if subjected to mechanical stress. Photoelastic experiments (also informally referred to as photoelasticity) are an important tool for determining critical stress points in a material and are used for determining stress concentration in irregular geometries. The photoelasticity technology is based on the double refraction phenomenon. If a model is made of a photoelastic material at a certain scale, in an unsolicited state, the model is optically isotropic, having the same refractive index in all directions. However, once the model is mechanically stressed, it becomes anisotropic and birefringent. The atoms in the mechanically stressed photoelastic material are thus unevenly distributed which causes different angles of light refraction, so that in areas with dense conglomerates of atoms, the angle of refraction is higher. The birefringent properties of materials differ from one material to another and even in the same type of material depending on how it has been arranged. For example, in one of the embodiments, the cellophane was stretched in a certain way which causes the light passing through this material to be visualized in a spectrum of colors that will change depending on the viewing angle and the position of the front polarizer 108. Several birefringent materials can be used such as cellophane, PET-G, transparent scotch tape, plexiglass, synthetic resins, or the like.

Several optical effects can be obtained by using the layered optical element according to the invention, such as:
The dimming effect, which is generated when the front polarizer 108 is rotated. This effect occurs when the light passes only through the two polarizers 108 and 111 and where no birefringent component is placed in between. The dimming intensity depends on the angle of rotation between the front polarizer and the rear polarizer.
The technical effect generated by stretched cellophane, which can be placed in various forms such as strips, conglomerates, or the like. The cellophane is placed in a transparent housing created by the two transparent disks 109c of the birefringent component 109 which are fixed on a plastic, wooden, or metal ring 109a. The transparent housing thus formed has a width that allows the stretched cellophane to form a three-dimensional structure configured in the desired shape.
The technical effect generated by the layered adhesive tape, which is applied on a thin transparent disk, which could be made of a glass or acrylic. The tape forms geometric patterns by overlapping. The transparent disk is positioned in a metal, plastic, or wooden frame 109aa. The color of the light passing through this type of material will depend on the number of layers.
The effect generated by the wrinkled adhesive tape, which is placed in the form of various structures formed by a single strip or several strips, conglomerates, or any other shape, which are placed in a transparent housing created by the two transparent plates 109c of the birefringent component 109, which are fixed on a plastic, wooden, or metal ring 109a. The transparent housing thus formed has a width that allows the structures of wrinkled adhesive tape to form three-dimensional structures configured in the desired shape. The term “wrinkled” refers to the folding of the adhesive tape in various directions and its stretching in various degrees of stretching depending on the birefringent characteristics predetermined for the layered optical element.
The effect generated by the various birefringent materials arranged in various shapes, such as thin layers in the form of discs of PET-G, polycarbonate, or other transparent materials having the same optical properties. In this case, a single color or a color gradient can be obtained. These materials can also be used in various shapes, such as strips or polygonal shapes, not necessarily disks. The transparent discs are placed in a frame made of metal, plastic, or wood 109aa.

The four effects can be used either separately or in various combinations, depending on the optical effect desired. For example, the stretched cellophane can be enclosed in a frame with other birefringent materials. One way of adjusting the effect created by the birefringent component 109 can be achieved by varying the position of the birefringent component 109 relative to the two polarizers by progressively moving it inside a middle channel to predetermined positions between the position where it completely overlaps with the two polarizers and the position where it is outside the two polarizers.

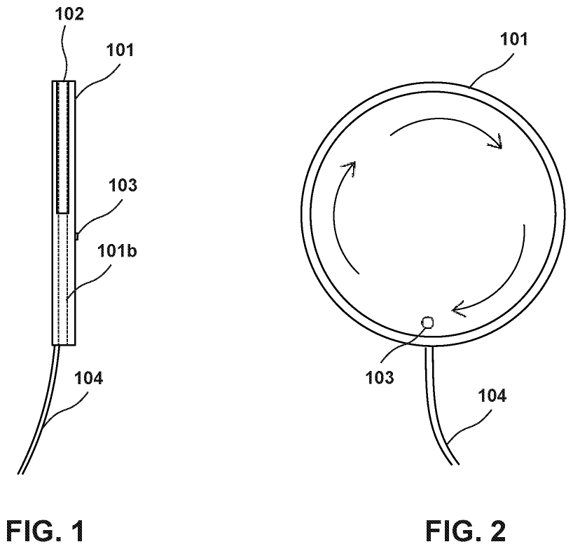

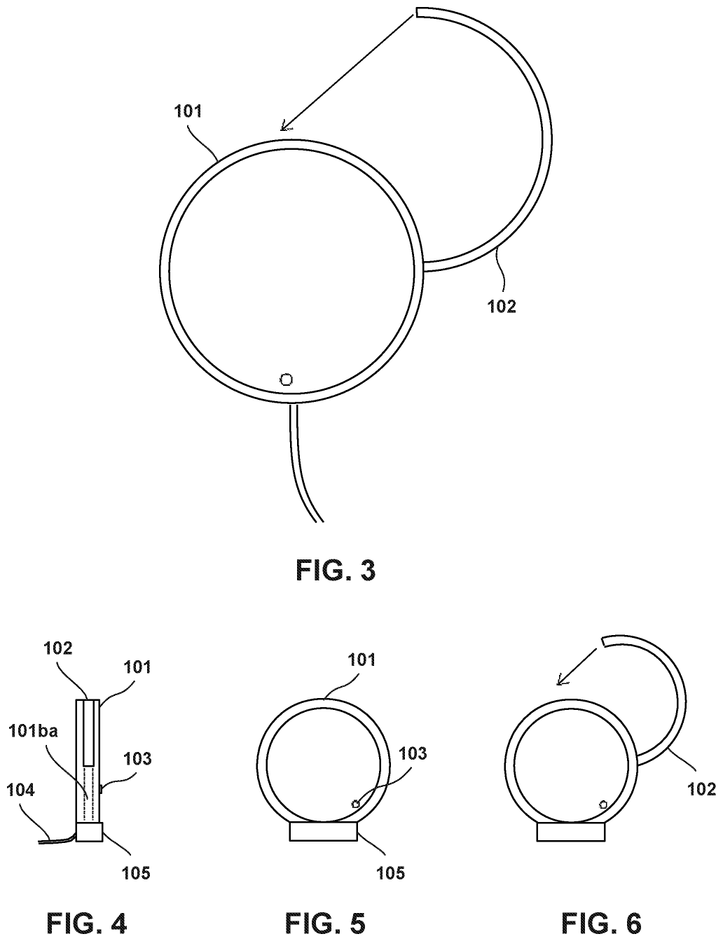

In the embodiment, shown in FIG. 1, a wall lamp comprises the layered optical device according to the invention, wherein the housing 101 comprises 3 channels, the channel in which the rear polarizer 111 is placed, the middle channel which is covered with a lid 102, in which the birefringent materials are positioned, and the channel in which the front polarizer 108 is placed. A nob 103, positioned on the front polarizer 108, allows the rotation of the front polarizer 108 in the channel as shown in FIG. 2. The lamp also has a power cord 104. The closing-opening mechanism of the lid 102 of the middle channel in which the birefringent materials are positioned is presented in FIG. 3.

In another embodiment of the invention, the layered optical device is part of a table lamp as shown in a side view in FIG. 4, and as shown in a front view in FIG. 5 and FIG. 6, where the lid's closing-opening mechanism is shown. The table lamp is composed of a stand 105 and in this embodiment, the middle channel can accommodate various birefringent materials which allow the visualization of white light's spectrum.

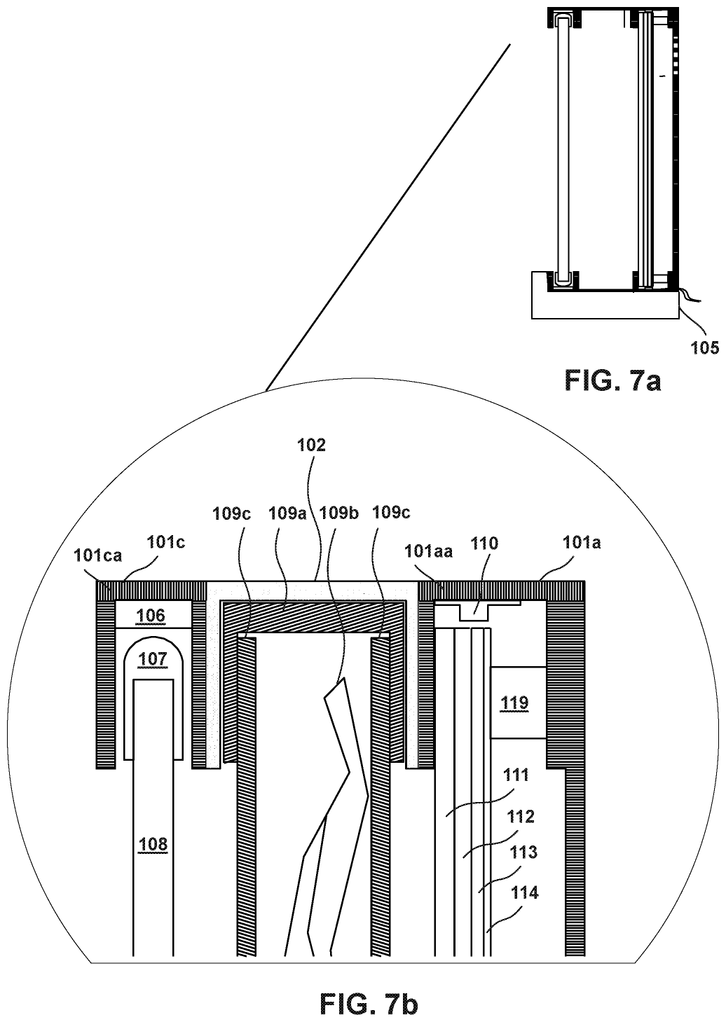

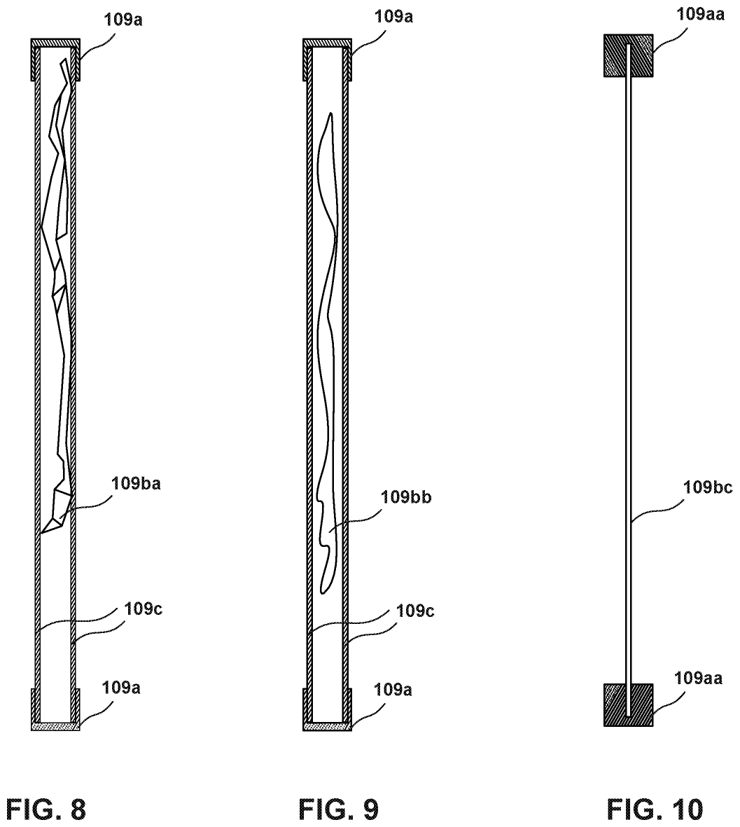

FIG. 7a shows a section of the side view of a layered optical element part of a table lamp, and FIG. 7b shows a detail view of this section, in which the composing elements can be seen in detail. Although the figure illustrates the particular case of the embodiment of a table lamp, the components presented as well as their assembly mode are also found in the other embodiments which comprise a light source 110. Thus, FIG. 7b shows the two rings that enable a smooth rotation of the front polarizer 108, the outer ring 106, which is mounted in a channel part of the lamp housing 101, and the inner ring 107, which has a channel that encloses the front polarizer 108. The two rings are made of wear-resistant materials, such as Teflon, plastic, or other similar materials. The front polarizer 108 comprises a polarization filter which may be placed on a transparent disk, or between two disks made of glass, plexiglass, or other similar materials. The filter can be linear, circular, elliptical, or rotary. The birefringent component 109 is composed of an outer ring 109a, which is positioned under the cover 102 and is placed in the middle channel, part of the housing 101 of the layered optical device. The birefringent material 109b is placed in the outer ring 109a and between the transparent disks 109c. The birefringent material 109b can be any kind of material that has birefringent properties, namely a fluctuating refractive index correlated to mechanical deformations and or to the viewing angle. An artificial lighting element is placed in a channel of the housing 101. In this case, the light source is a LED strip 110 placed on the inner circumference of the channel. In the frontal part oriented towards the birefringent element and, respectively, towards the front polarizer 108, the rear polarizer 111 is placed, which consists of a polarizing filter placed on a disk or between two transparent disks of glass or Plexiglas or other similar material. Behind the rear polarizer 111, a lights diffusion plate 112 is placed, which may be made out of polycarbonate or polystyrene or other similar material, a light guide panel 113, which is made of optically structured acrylic or acrylic engraved with light guiding patterns, and a white reflective disk 114. FIGS. 8, 9, 10 illustrate several types of the birefringent components 109. FIG. 8 shows the birefringent component 109 that is of the birefringent material 109b wrinkled tape type. It is comprised of the tape marked with 109ba, which generates the main effect 1, called wrinkled tape type 109ba. FIG. 9 shows the birefringent component 109 of the photoelastic material stretched cellophane type 109b. It is comprised of the stretched cellophane 109bb, which generates the main effect 2, called stretched cellophane type 109bb. FIG. 10 shows the birefringent component 109 comprising the birefringent material 109bc: polycarbonate or Polyethylene Terephthalate Glycol (PET-G) or other similar material generating the main effect 3: PET-G or polycarbonate type. In this case, the birefringent component 109 consists of the outer ring 109aa, which is designed to enclose only the birefringent material 109bc. Transparent plates 109c, used in other birefringent components 109b, as presented above, are no longer required in this embodiment.

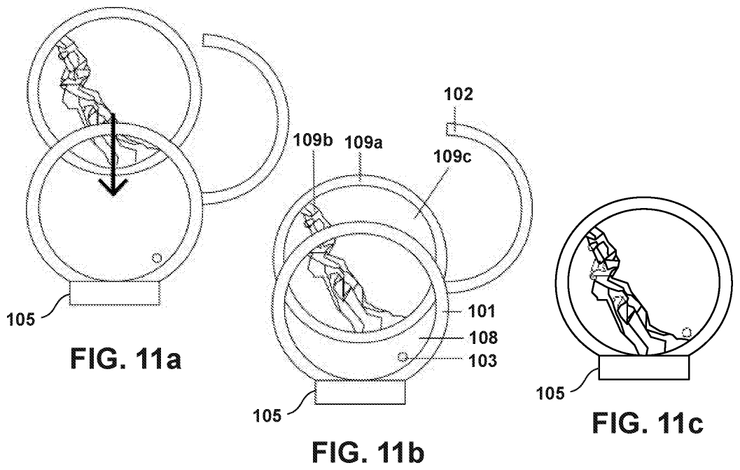

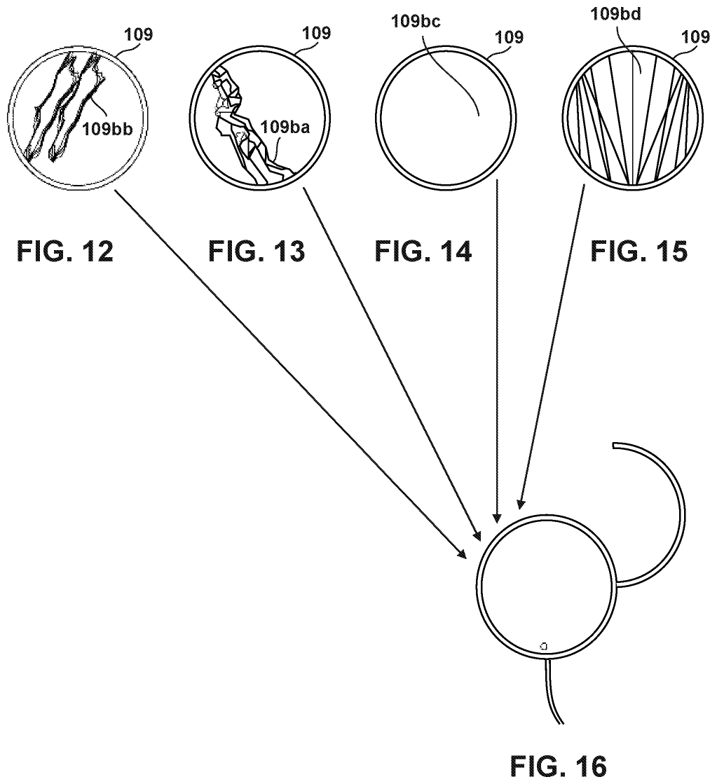

FIG. 11a, FIG. 11b, and FIG. 11c show, in front view, the insertion of the birefringent component 109 into a channel, a part of the housing 101 of the layered optical element incorporated in a table lamp. The lid's (102) closing motion is also depicted. FIG. 12-FIG. 16 show, in front view, the insertion of different types of the birefringent components 109 in a channel of the housing 101 and the closing motion of the cover 102, part of the layered optical element incorporated in a wall lamp. FIG. 12 shows the birefringent component 109, composed of the photoelastic material 109b of the stretched cellophane type 109bb, generating the main effect 2. FIG. 13 shows the birefringent component 109, composed of the birefringent material 109b of the wrinkled adhesive tape type 109ba, generating the main effect 1. FIG. 14 shows the birefringent component 109, composed of the birefringent material 109bc such as PET-G or polycarbonate, generating the main effect 3. FIG. 15 shows the birefringent component 109, composed of the birefringent material 109b of the layered adhesive tape type 109bd, generating the main effect 4. FIG. 16 schematically depicts the insertion of different types of the birefringent components 109, as shown in FIGS. 12-15, in a channel of the housing 101, which is illustrated with the lid open.

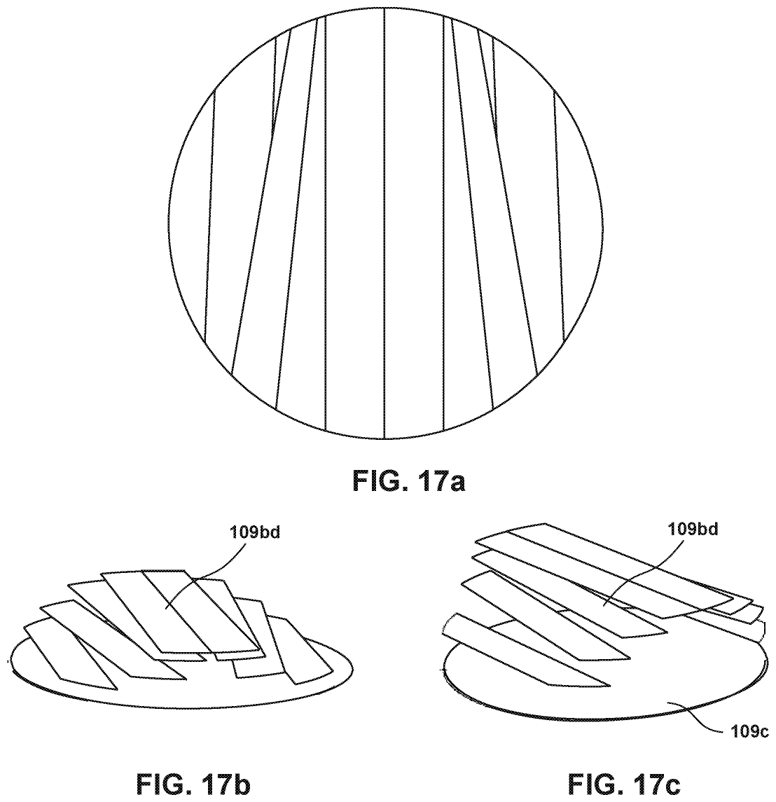

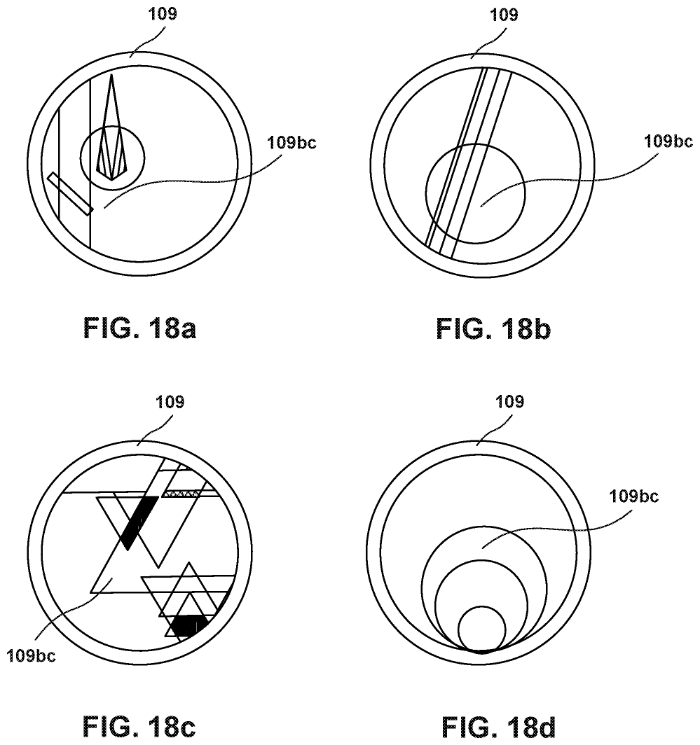

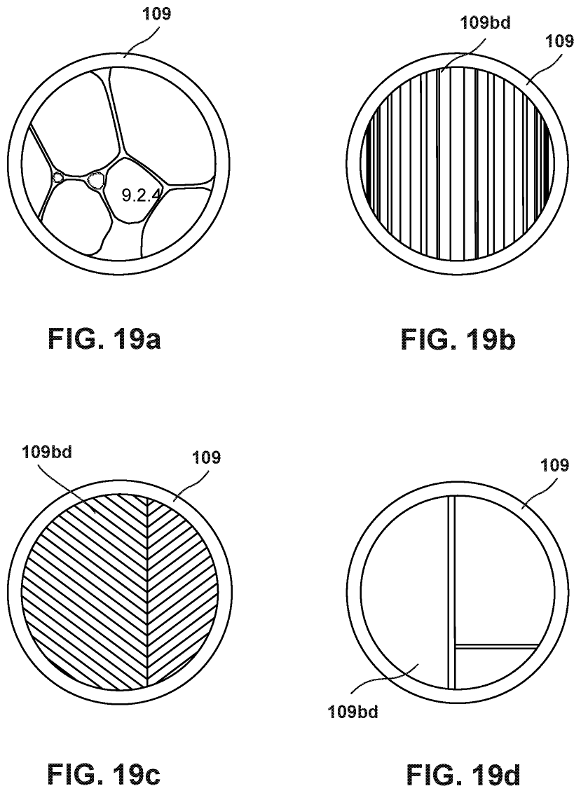

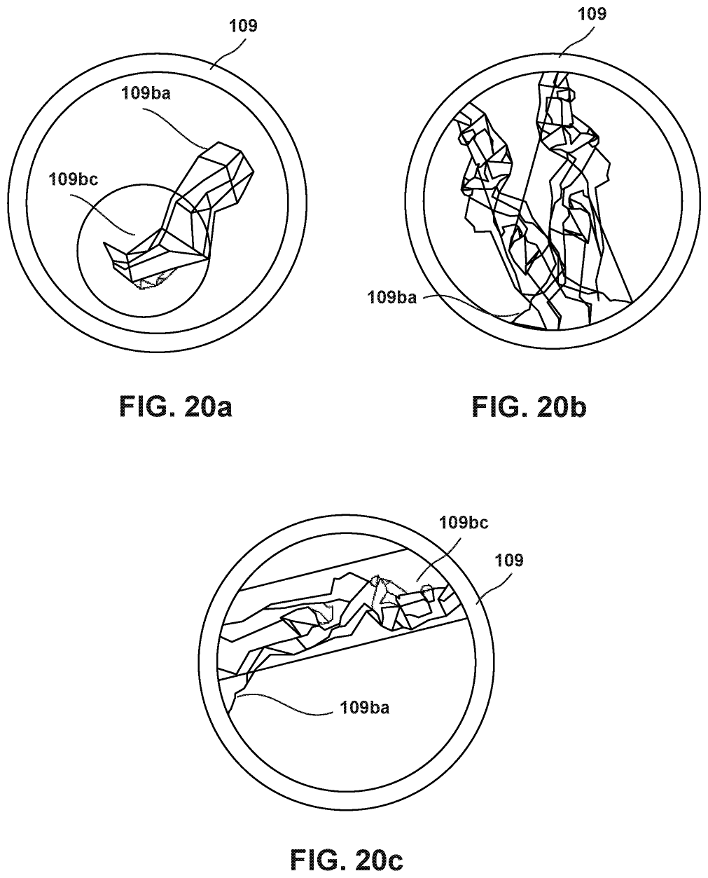

FIGS. 17a-17c show the birefringent component 109, composed of the birefringent material 109b of the layered adhesive tape type 109bd, as well as the process of obtaining a birefringent material of the layered adhesive tape 109bd, where 109bd is the adhesive tape and 109c is an acrylic or glass disk on which the layered tape is glued. FIGS. 18a-18d present, in front view, the birefringent components 109 where the birefringent material 109bc (such as polycarbonate plate or Polyethylene Terephthalate Glycol (PET-G) is designed in a mosaic style. These are variations of the main effect 3. FIGS. 19a-19d show, in front view, the birefringent components 109 of the layered adhesive tape type 109bd in various embodiments, generating variations of the main effect 2. FIGS. 20a-20c show, in front view, the birefringent components 109 of the wrinkled adhesive tape type 109ba in various embodiments, generating variations of the main effect 1. FIGS. 20a and 20c show, in front view, the birefringent components 109 embodying a mix of the wrinkled adhesive tape birefringent material 109ba and the polycarbonate or Polyethylene Terephthalate Glycol (PET-G) birefringent material 109bc, each generating the corresponding effects.

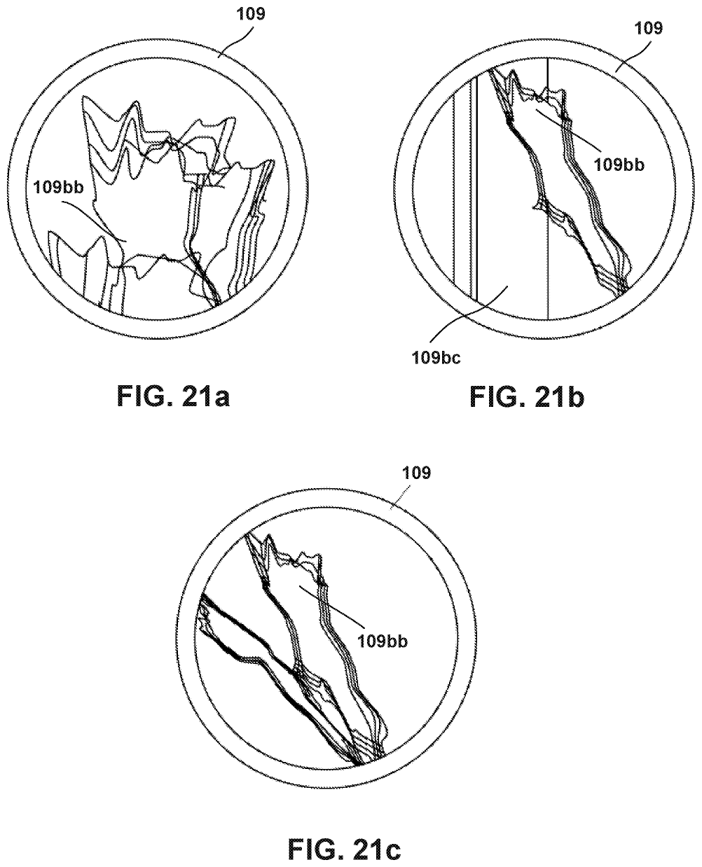

FIGS. 21a-21c show, in front view, a photoelastic component 109 of the stretched cellophane type 109bb in various embodiments, generating variations of the main effect 2. FIG. 21b shows, in front view, the birefringent component 109 embodying both a stretched cellophane photoelastic material 109bb and a birefringent material 109bc such as polycarbonate plate or Polyethylene Terephthalate Glycol (PET-G).

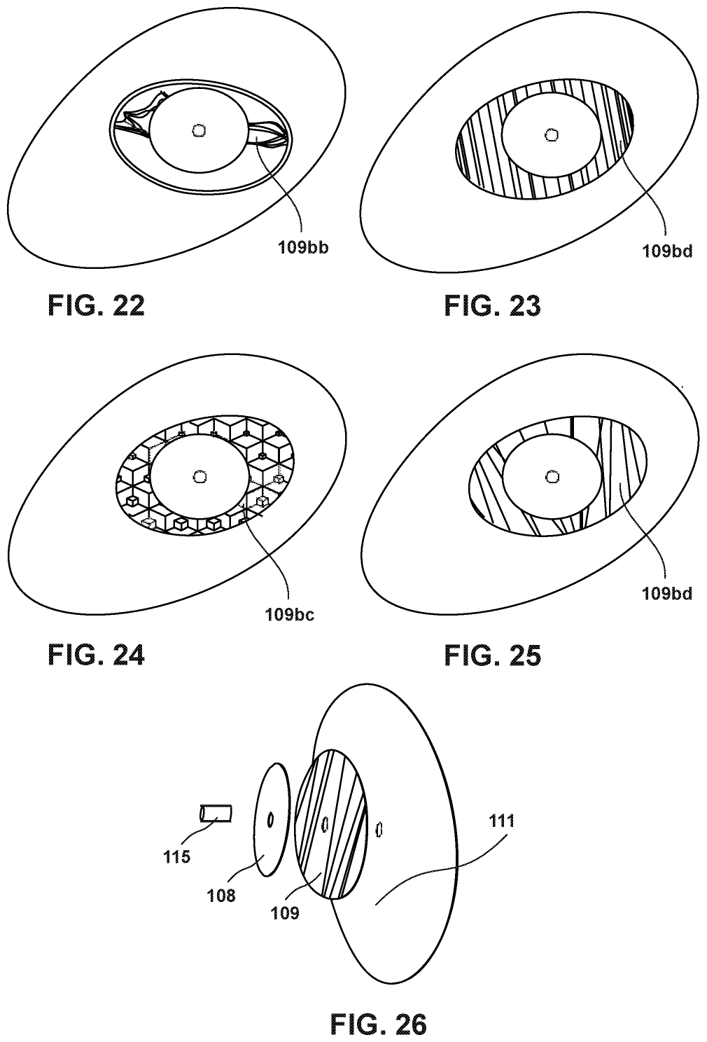

Another embodiment of the layered optical device according to the invention is shown in FIGS. 22-25, where no artificial lighting source is incorporated in the device. The layered optical device thus designed allows the visualization of the colors composing the white light spectrum through processes of diffraction, refraction, birefringence, and interference. The layered optical device comprises various birefringent materials placed between two polarizers. The device illustrated in FIGS. 22-25 has a central pivot 115, which enables the rotation of the front polarizer 108 and the birefringent component 109. The birefringent component 109 of the layered optical device, illustrated in FIG. 22, is composed of the birefringent material 109bb i.e., a piece of stretched cellophane, while those illustrated in FIG. 23 and FIG. 25 incorporate a layered adhesive tape element. In FIG. 24 the birefringent material 109b is placed between the polarizers and incorporates a collage of PET-G or polycarbonate material. FIG. 26 shows the layered optical device previously illustrated in FIG. 23 in an exploded view, wherein the rear polarizer 111 is comprised of the rear polarization filter, which is placed on a disk or between two acrylic or glass disks. The birefringent component 109 consists of the birefringent material 109bd of the layered adhesive tape type, which is placed on an acrylic or glass disk 109c. The birefringent component 109 can be interchanged with any of the variations shown in FIGS. 22-25. The front polarization filter is fixed on a disk or between two disks of acrylic or glass and can be manually rotated around a pivoting rod 115, by means of which all the components of the layered optical device are joined.

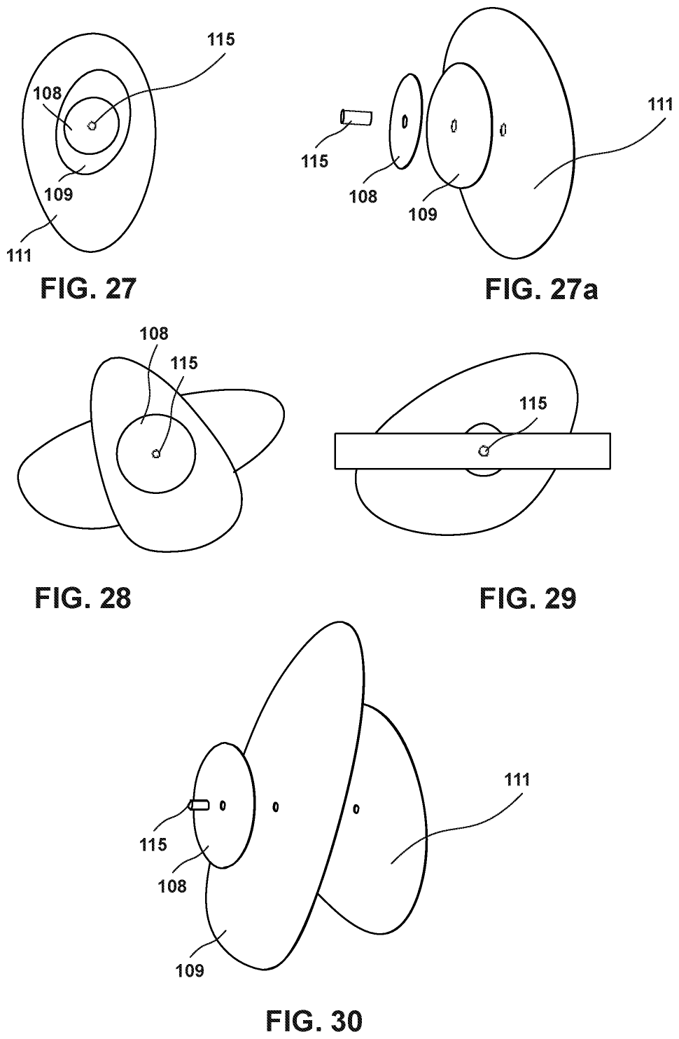

FIGS. 27-30 present several embodiments of the layered optical device according to the invention, which do not incorporate a lighting source, but do incorporate several types of birefringent materials that enable the visualization of the spectrum of white light through processes of diffraction, refraction, birefringence, and interference when placed between two polarizing filters. The birefringent materials 109b are interchangeable as shown in FIGS. 27-30. FIGS. 27a and 30 illustrate the exploded views of the layered optical device, where the front polarizer 108 can be manually rotated around the pivoted rod 115.

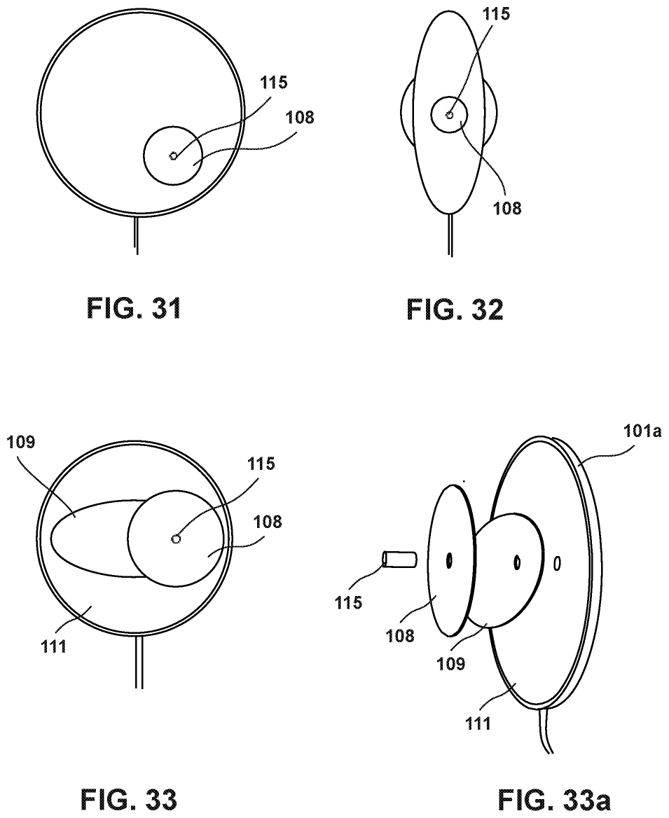

FIGS. 31-33 show several variations of the luminaire, comprising the layered optical device according to the invention, where the three main components, namely the front polarizer 108, the birefringent component 109, and the rear polarizer 111 have different shapes. FIG. 33a illustrates in an exploded view the composing elements of the luminaire. The composing elements of the rear part 101a are as shown in FIG. 7b. In addition, the lamp has the possibility of manually rotating the birefringent component 109 around the pivot rod 115.

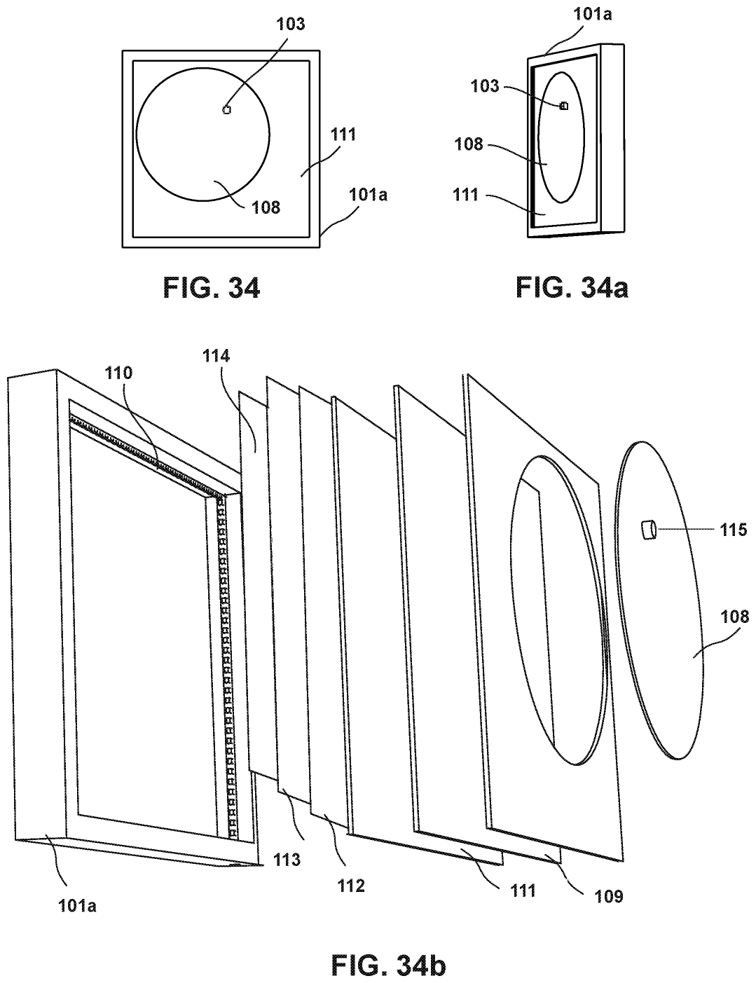

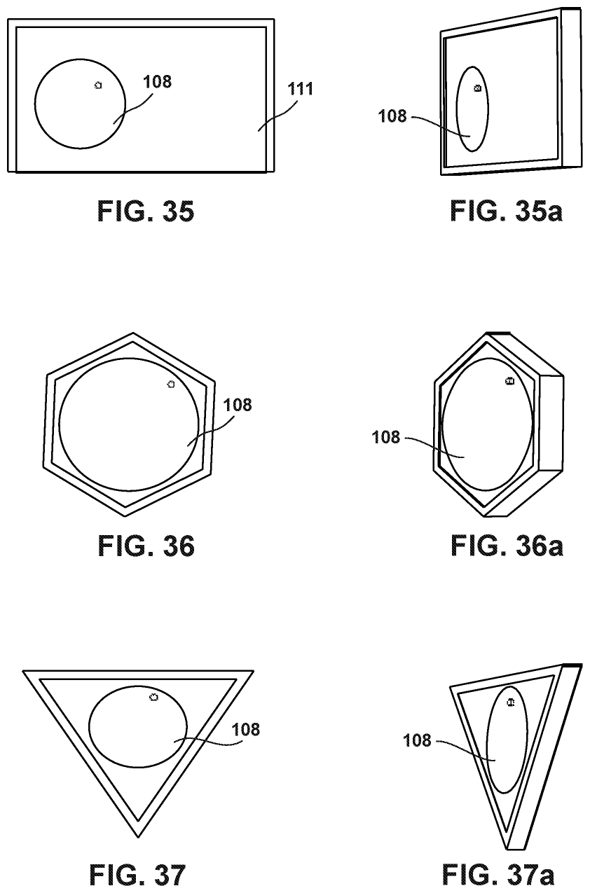

FIGS. 34-37 show, in front view, and FIGS. 34a-37a show, in perspective view, several variants of the luminaire as illustrated. In this case, the layered optical device, according to the invention, is comprised of three main components with different shapes, respectively, the front polarizer 108, the birefringent component 109, and the rear polarizer 111. Thus, the polarization effect is only visible through the front polarizer 108. Birefringent materials 109b are not exchangeable in this case. The front polarizer 108 can be rotated using the nob 103. The housing 101 incorporates a lighting element such as a LED strip and the light diffusion elements as previously shown in FIG. 7b. FIG. 34b presents an exploded view of the lamp as previously shown in FIG. 34 and FIG. 34a, where the components of the layered optical device are illustrated as follows: the polarizer 108 composed of a polarizing filter, which is placed on a disk or between two glass or acrylic disks and which can be rotated using the pin 103. The rear part 101a of the housing 101 contains a lighting element, the LED light strip 110, the polarizer 111, the light diffusion plate 112, the light guide plate 113, and the reflective foil 114.

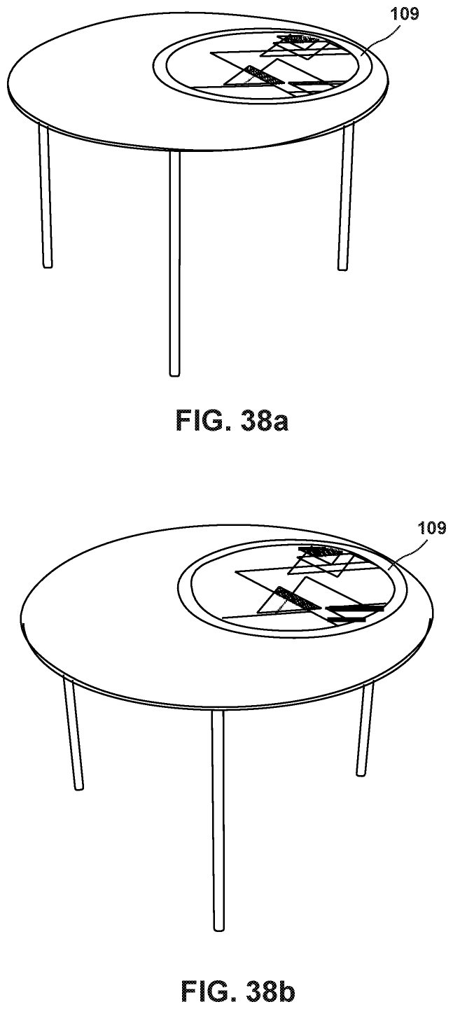

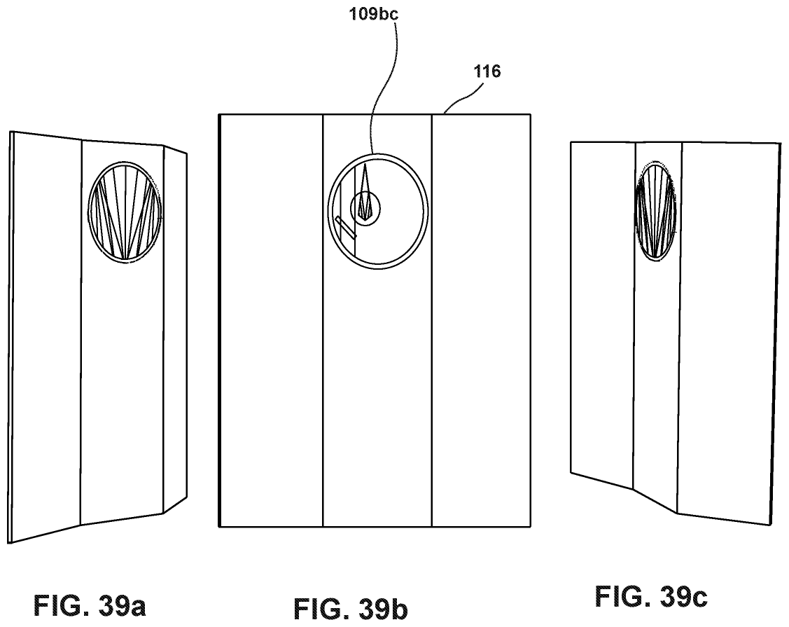

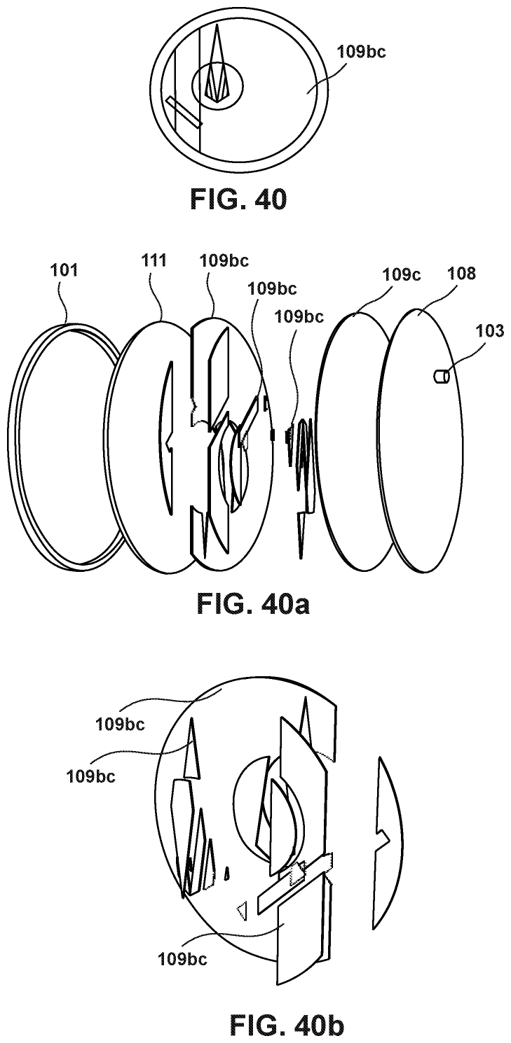

FIGS. 38a and 38b show the layered optical device, according to the invention, without artificial light source incorporated in a furniture piece, namely a table. FIGS. 39, 39b, and 39c show the layered optical device, according to the invention, without artificial light source incorporated in a room screen or divider. FIG. 40 shows the layered optical device, according to the invention, without an artificial light source, and in FIG. 40a, it is illustrated in an exploded view. The birefringent material 109b of the birefringent component 109 consists of a collage of polycarbonate or PET-G 109bc pieces as shown in FIG. 40b. The housing 101 of the layered device incorporates the rear polarization filter placed on a disk or between two transparent disks, the collage of polycarbonate parts or other birefringent material with similar properties 109bc, the transparent plate 109c of the birefringent component 109, and the front polarizer 108, which can be rotated using the rod 103.

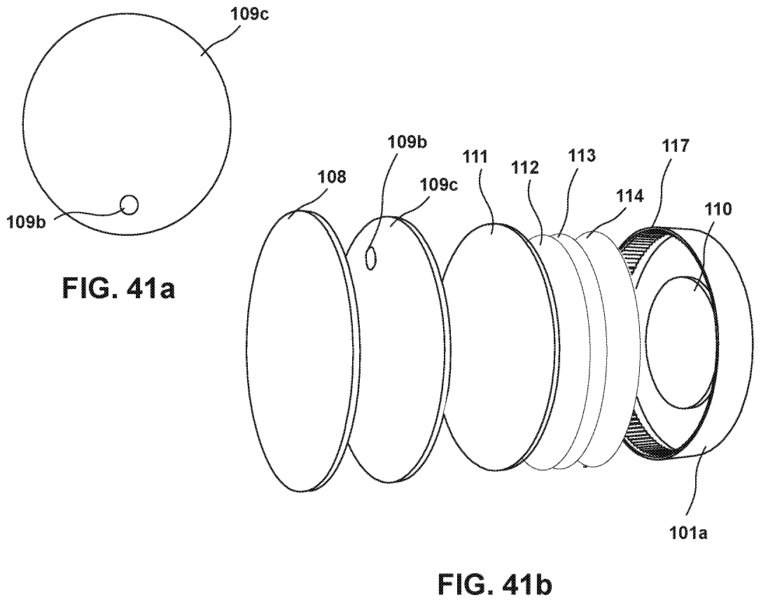

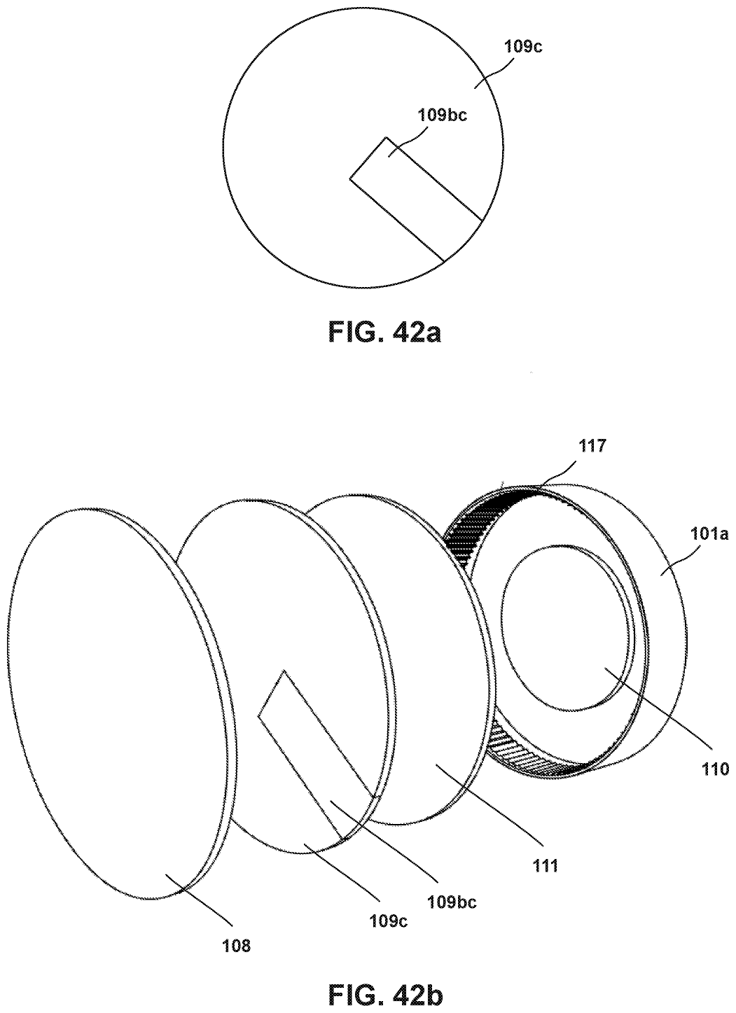

FIG. 41a, FIG. 42a and FIG. 41b, FIG. 42b illustrate front and exploded views of variations of the layered optical device, according to the invention, adapted to be incorporated in a clock or luminaire with automatic rotation. These are just a few embodiments, which do not limit the scope of the invention. Other possible embodiments may vary in shape and arrangement of the components comprising the layered optical device. The birefringent component 109, which is placed between the two polarizers 108 and 111, may also vary in shape and material (PET-G, cellophane, adhesive tape, etc.). FIG. 41b shows an exploded view of a clock or an automatically rotating luminaire incorporating the layered optical device, in which 109b represents the birefringent material, 108 is the front polarizer comprising the polarization filter placed on a plate or between two acrylic or glass plates, 111 is the rear polarizer comprising the rear polarization filter placed on a plate or between two transparent plates, 112 is the light diffusion plate, 113 is the guide plate, and 114 is the reflective foil. The frame of the clock or luminaire with automatic rotation is marked with 101a. Inside it, the artificial light source 110 and the automatic rotation mechanism 117 are mounted. The discs are rotated automatically by means of the rotating mechanism 117 and indicate the time using the disc marked 109b. The middle disc 109c is rotated clockwise inside the housing 101, so that the birefringent material 109b and the birefringent plate 109c change color as they rotate. FIG. 42b shows the other non-limiting embodiment of a clock or luminaire with automatic rotation incorporating the layered optical device, in which 109bc represents the birefringent material, which can be made of PET-G, cellophane, adhesive tape, or polycarbonate, 109c represents the transparent disk, which can be made of glass, acrylic, or even birefringent material such as PET-G or polycarbonate, 108 represents the front polarizer, and 111 represents the rear polarizer. The discs are rotated automatically by means of the rotation mechanism 117 and indicate the time using the birefringent material 109bc. The middle disk 109c rotates clockwise in the housing 101 so that the birefringent material 109bc changes color.

In another embodiment of the invention, both the disk 109c and the front polarizer 108 may be rotated simultaneously, either at the same speed or at different speeds, causing a color changing effect in the birefringent element 109bc and a dimming effect of the transparent plate 109c from 1% to 98%. Although several embodiments of the invention have been described in detail, the invention is not limited by them, but obviously includes all changes and modifications within the scope of the invention as defined by the appended claims.

I claim:

1. A layered optical device, comprising:
three main parts comprising:
a rear part (101a),
a front part (101c), and
a middle part (101b) that is placed between the rear part (101a) and the front part (101c) by means of a mechanism enabling a lid (102) to move sideways relative to the other two parts, in which:
the rear part (101a) is designed to incorporate a rear polarizer (111);
the front part (101c) includes:
a front polarizer (108);
means of encasing (106, 107) the front polarizer (108) which allow rotation of the front polarizer (108) around its center of mass relative to the rear polarizer (111); and
means for rotating (103, 115) the front polarizer (108); and
the middle part (101b) comprises of a birefringent component (109) which allows visualization of light passing through it under phenomenon of birefringence, refraction, and polarization, and
wherein the layered optical device is configured such that the intensity and color spectrum of the light passing through it are determined by the angle of rotation of the front polarizer (108) relative to the rear polarizer (111), the optical characteristics of the birefringent component (109), the position of the birefringent component (109) in relation to the front polarizer (108) and the rear polarizer (111) and a viewing angle.

2. The layered optical device according to claim 1, wherein each of the front polarizer (108) and the rear polarizer (111) comprises a linear, circular, elliptical, or rotary polarization filter (not shown) and is configured so that the intensity of the polarized light passing through the optically layered device is adjustable by rotating the front filter (108) using its means of rotating (103) relative to the rear filter (111).

3. The layered optical device according to claim 1, wherein the means for enclosing (106, 107) the front polarizer (108), which enable the rotation of the front polarizer (108) in a front channel, are formed by two rings including an outer ring (106), which is configured to be mounted in a front channel, and an inner ring (107), which is configured to encase the front polarizer (108) and rotate it inside the outer ring (106).

4. The layered optical device according to claim 1, wherein the birefringent component (109) comprises a birefringent material (109b) that is selected from the following elements separately or in combination: (1) stretched cellophane strips that are arranged in three-dimensional shapes, (2) wrinkled adhesive tape that are arranged in three-dimensional shapes, (3) layered adhesive tape formed by overlapping layers of adhesive tape, (4) polycarbonate parts with disks or other geometrical shapes, and (5) Polyethylene Terephthalate Glycol (PET-G) parts in a disks or other geometrical shapes,
wherein these materials are configured to be incorporated into the birefringent component (109) according to predetermined birefringent optical characteristics and light intensity and color spectrum desired.

5. The layered optical device according to claim 1, wherein the layered optical device is composed of a housing (101) comprising:
the rear part (101a) and the front part (101c) that are designed to have a fixed position;
the middle part (101b) having the lid (102), which can rotate laterally in relation to the other two parts (101a, 101c); and
means for fastening the lid (102), which enable a lateral rotational movement in relation to the front polarizer (108) and the rear polarizer (111), and allow the position of the birefringent component (109) to be adjusted relative to the two polarizers, the front polarizer (108) and the rear polarizer (111), by rotating the birefringent component (109) of the middle part (101b) to predetermined positions between a completely overlapping position with the front polarizer (108) and the rear polarizer (111) and a position outside the two polarizers.

6. The layered optical device according to claim 5, wherein the birefringent component (109) is composed of an outer ring (109a) configured to comprise inside two transparent disks (109c) and a birefringent material (109b) placed between the two disks (109c) which are made of glass, acrylic, or other material with similar optical properties, and wherein the middle part (101b) is composed of a middle channel configured to comprise the birefringent component (109), having a folding part (102) that is configured so that it allows insertion of the birefringent component (109) in the middle channel.

7. The layered optical device according to claim 6, wherein at least one of the front polarizer (108) or the rear polarizer (111) comprises one or two transparent plates (not shown) on which polarization filters (not shown) are glued on, or are placed between two disks of type (not shown), respectively, which are made of glass, acrylic, or other material with similar optical properties.

8. The layered optical device according to claim 1, wherein the layered optical device is adapted to be incorporated in a luminaire such as a wall lamp, a ceiling lamp, a desk lamp, or other similar lighting devices.

9. The layered optical device according to claim 8, wherein means adapted for incorporation into the luminaire are:
the rear part (101a) of the housing (101) comprising a light source (110) mounted on an inner circumference of the housing (101) in the rear part (101a), and
wherein a posterior canal (101aa) is adapted to comprise at least one light guide plate (113), at least one light-reflecting film (114), and a light diffusion plate (112) that is placed between the light guide plate (113) and the rear polarizer (111).

10. The layered optical device according to claim 1, wherein the layered optical device is adapted to be incorporated into a piece of furniture.

11. The layered optical device according to claim 1, wherein the layered optical device is adapted to be incorporated into a wall or a room divider (116).

12. The layered optical device according to claim 1, wherein the layered optical device is adapted to be incorporated into a clock or an automatically rotative luminaire.

13. The layered optical device according to claim 1, wherein means for mounting the front polarizer (108), which allow the front polarizer (108) to rotate relative to the rear polarizer (111) and the birefringent component (109), comprise a pivoted rod (115), wherein these means allow the front polarizer (108), the rear polarizer (111), and the birefringent component (109) to be mounted and rotated around the pivoted rod (115) in predetermined positions, which helps in obtaining predetermined values of light intensity and color frequencies.

14. The layered optical device according to claim 1, wherein the layered optical device has a polygonal or circular shape.

15. The layered optical device according to claim 1, wherein a middle channel is adapted to allow interchangeability of the birefringent components (109).
